(19) United States
(12) Patent Application Publication
(10) Pub. No.: US 2005/0040580 A1
(43) Pub. Date: Feb. 24, 2005

(54) Cutting board

(76) Inventor: Philip H. Davis, Mercersburg, PA (US)

Correspondence Address: JAMES RAY & ASSOCIATES, 2640 PITCAIRN ROAD, MONROEVILLE, PA, 15146, US

(21) Appl. No.: 10/916,830

(22) Filed: Aug. 12, 2004

Related U.S. Application Data
(63) Continuation-in-part of application No. 10/324,285, filed on Dec. 19, 2002.

(51) Int. Cl. B23Q 3/00

(52) U.S. Cl. 269/289 R

(57) ABSTRACT

A cutting board comprises a first member having a first predetermined shape and a predetermined thickness. The first member has at least two outer edges engageable with at least two radially opposed sides of a support member. The first member having sufficient cut resistant properties and heat resistant properties for cutting at least one of hot and cold food products thereon and having sufficient strength to support such food products to be cut. There is a first surface of the first member having a first predetermined size for holding such food products to be cut and a second surface of the first member having a second predetermined size. A means is provided for allowing juices from such food products to be cut to drain from the cutting board.

### CROSS REFERENCE TO RELATED APPLICATIONS

This application is a continuation-in-part and claims benefit of U.S. application Ser. No. 10/324,285 filed on Dec. 19, 2002, now abandoned.

The invention taught in this patent application is closely related to the invention taught in the following co-pending patent application, FREE STANDING CUTTING BOARD, Ser. No. 10/324,292 which was filed on Dec. 19, 2002. These patent applications are assigned to the same assignee and the teachings therein are incorporated into this application by reference thereto.

### FIELD OF THE INVENTION

The present invention relates, in general, to cutting boards for kitchen use and, more particularly, this invention relates to a cutting board and drip pan combination wherein the cutting board fits securely to the top of a pan permitting the cutting to take place on top of the pan with any liquid draining into the pan.

### BACKGROUND OF THE INVENTION

Cutting boards have been used for many years to support the items to be cut and for providing a surface upon which the cutting can take place. Cutting boards have been made of wood and to some extent cut resistant plastic. For many years wood has been the preferred choice and it is only in recent times that plastic cutting boards have made an inroad on the wooden boards.

The cutting board routinely is placed on a table or counter top and the item to be cut is placed on the board. the item is cut with a knife which passes through the item till it reaches the cutting board. The board, therefore, provides protection for the table top or counter top and prevents the top from being marked up or cut during the cutting process.

One problem that occurs with cutting boards is that if the item being cut has juices then the liquid from the item, whether it be a roast, ham, turkey or whatever can drain off of the cutting board and drip onto the table top or counter top that supports the cutting board.

### SUMMARY OF THE INVENTION

The present invention, therefore, provides a cutting board which comprises a first member having a first predetermined shape and a predetermined thickness. The first member has at least two outer edges engageable with at least two radially opposed sides of a support member. The first member having sufficient cut resistant properties and heat resistant properties for cutting at least one of hot and cold food products thereon and having sufficient strength to support such food products to be cut.

There is a first surface of the first member having a first predetermined size for holding such food products to be cut and a second surface of the first member having a second predetermined size. A means for allowing juices from such food products to be cut to drain from the cutting board is provided.

In an alternate embodiment of the invention there is provided in combination with a drip pan tray having a first predetermined shape and having a base and one of a sidewall and sidewalls and endwalls connected to such base, the improvement comprising a cutting board mountable on the drip pan tray, the cutting board includes a first member having a first predetermined shape and a predetermined thickness. The first member has at least two outer edges engageable with at least two radially opposed sides of said drip pan tray. The first member having sufficient cut resistant properties and heat resistant properties for cutting at least one of hot and cold food products thereon and having sufficient strength to support such food products to be cut.

There is a first surface of the first member having a first predetermined size for holding such food products to be cut and a second surface of the first member having a second predetermined size. A means for allowing juices from such food products to be cut to drain from the cutting board is provided.

### OBJECTS OF THE INVENTION

It is, therefore, one of the primary objects of the invention to provide a cutting board which can be used with a variety of support members.

Another object of the present invention is to provide a cutting board that can be used at the table.

Still another object of the present invention is to provide a combination drip pan tray and cutting board in which the tray can be used to cook the products and then have the cutting mount on the tray after such food products are cooked.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a top view of a cutting board according to an embodiment of the invention

FIG. 2 is perspective view of the cutting board shown in FIG. 1.

FIG. 3 is a bottom view of the cutting board according to an embodiment of the invention.

FIG. 4 is a top view of a combination cutting board and drip pan according to an alternate embodiment of the invention.

FIG. 5 is a cross sectional view of FIG. 4 take across the line of V-V.

FIG. 6 is a perspective view of a cross section of the cutting board and drip pan combination.

FIG. 7 is a perspective view of a combination cutting board and drip pan according to an alternate embodiment of the invention.

FIG. 8 is a top view of a drip pan according to an embodiment of the invention.

FIG. 9 is a perspective view of the drip pan as viewed from the top according to an embodiment of the invention.

FIG. 10 is a perspective view of the drip pan as viewed from the bottom according to an embodiment of the invention.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

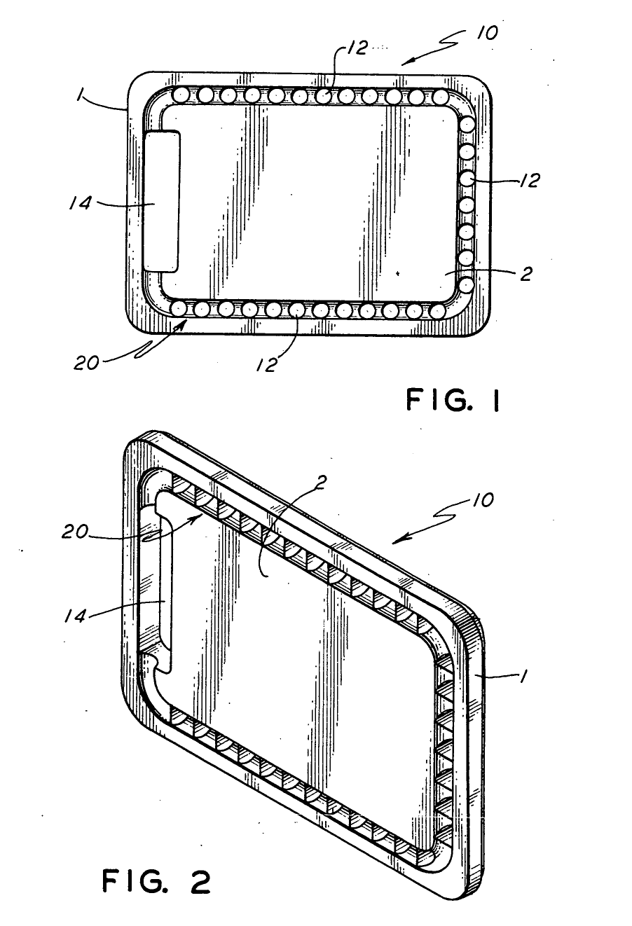

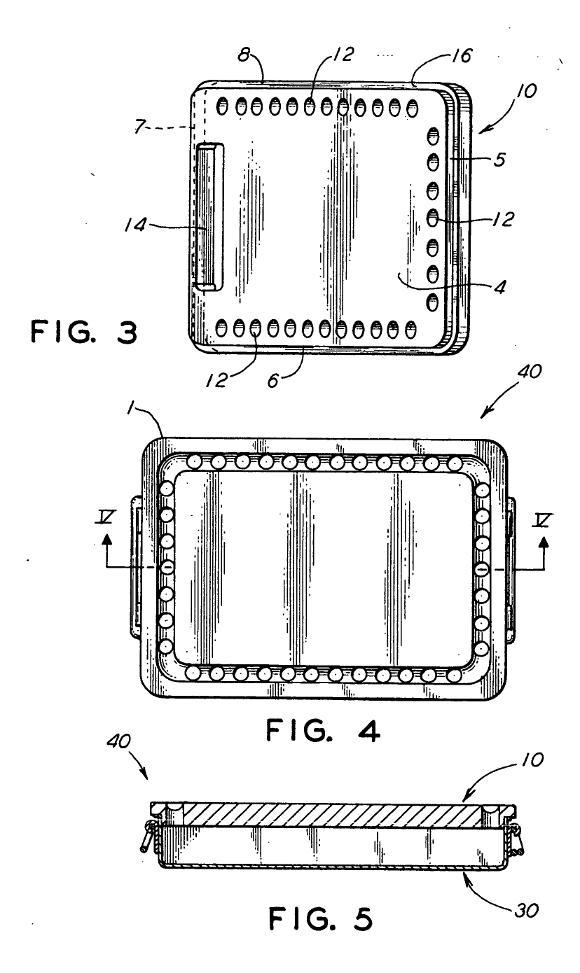

Illustrated in FIGS. 1-3 is a cutting board, generally designated 10, according to an embodiment of the invention. Such cutting board includes a first member 1 which has a top surface 2 and a bottom surface 4. Such first member is selected from a material having sufficient cut resistant properties and heat resistant properties for cutting both hot and cold food products and sufficient strength to support such food products to be cut. Such first member 1 is selected from a group including polypropylene, high density polyethylene and wood. Such wood further includes laminated or ingrained wood. It is presently preferred that such cutting board be polypropylene.

First member 1 has at least two outer edges 5,6,7 and 8 for engaging at least two radially opposed sides of a support member (not shown in FIG. 1). In all the drawings such support member is shown as a rectangular drip pan; however, such support member could be a Dutch oven, roaster, pot or any shaped pan. The drawings also show the cutting board 10 as being rectangular; however, it is within the scope of the invention that such cutting board could be round, oval, square or rectangular. It is presently preferred that such cutting board be rectangular so as to fit a rectangular drip pan.

As is clearly evident in the Drawing Figures such top surface 2 and such bottom surface 4 of such first member 1 are substantially solid; however, such cutting board 10 further includes a means, generally designated 20, for allowing the juices from the food products being cut to drain from the cutting board 10. Such means 20 may include a plurality of apertures 12 which are disposed closely adjacent an outer edge of the first member 1. Such means 20 may also include a larger aperture 14 disposed at one end of the first member 1.

Such first surface 2 of first member 1 has a first predetermined size for holding such food product to be cut. Second surface 4 of first member 1 has a second predetermined size. It is presently preferred that such second predetermined size be smaller that the first predetermined size. By having the second surface 4 being smaller that such first surface 2, a lip or groove 16 is formed in the first member 1 on the bottom surface 4. This lip 16 permits the cutting board 10 to rest securely on a support member.

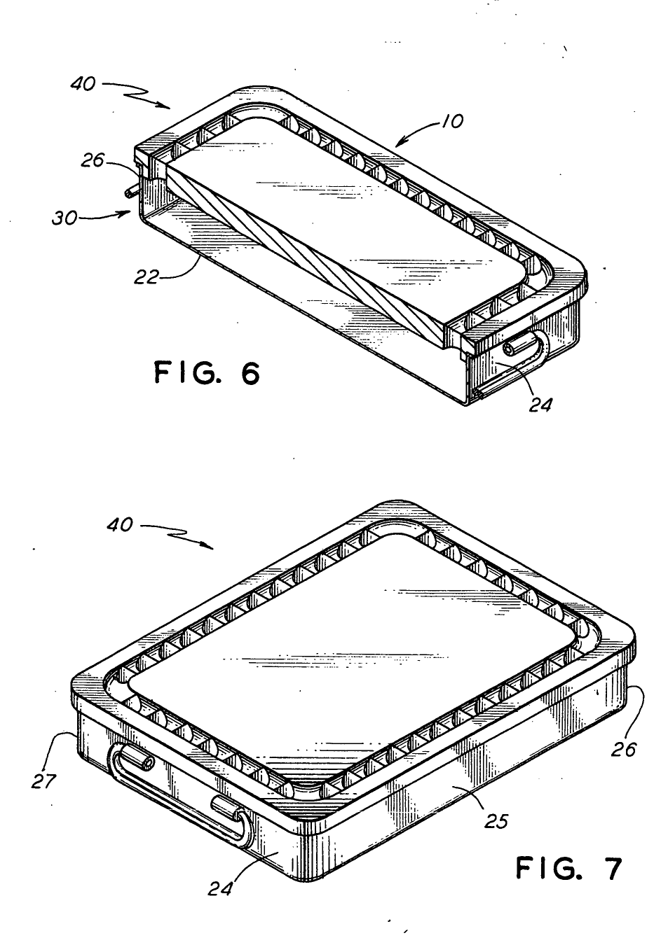

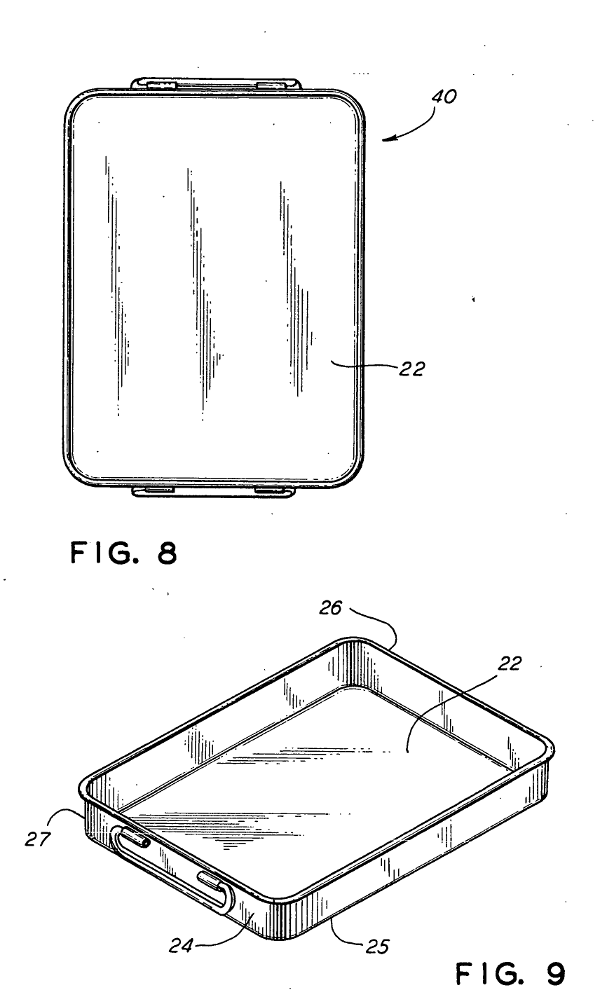

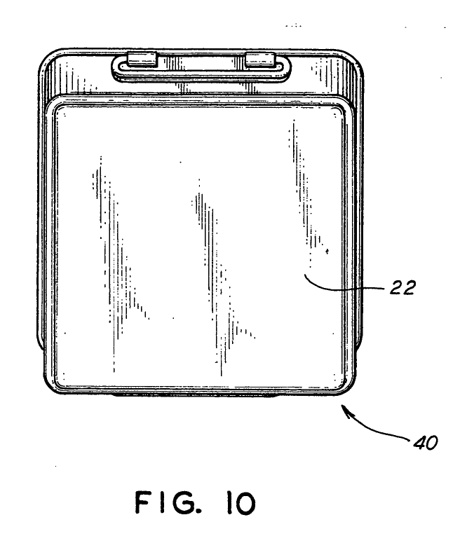

Illustrated in FIGS. 4-8 is a combination, generally designated 40, which includes a cutting board 10 and a drip pan, generally designated 30. The combination 40 can be used in both cooking a food product and later cutting the food product. The drip pan 30 can be used to cook food in the oven and then have the cooked food product placed on the cutting board 10 which sits on top of drip pan 30, so that any juices drain back into the drip pan 30.

Such combination 40 includes a cutting board 10, as described previously and a drip pan 30. Drip pan 30 has a base 22, sidewalls 25,27 and endwalls 24,26. Again as mentioned previously such drip pan is shown as being rectangular thereby having four sides (two sidewalls and two endwalls); however, it is within the scope of the invention that such support member may also be oval, as with a roaster, round, such as a Dutch oven or square as are some roasting or drip pans. In the case of a round support member such member would only have one side which would be a continuous side without any endwalls. It is presently preferred; however, that such support member be rectangular so as to fit in the most common drip pans.

Such cutting board 10 sits securely on top such drip pan 30 with the lip 16 of first member 1 sitting on the top of the sidewalls 25,27 and endwalls 24,26 of drip pan 30.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

1. A cutting board comprising:
(a) a first member having a first predetermined shape and a predetermined thickness, said first member including at least two outer edges having a bottom surface engageable with an upper surface of at least two radially opposed sides of a support member, said first member having sufficient cut resistant properties and heat resistant properties for cutting at least one of hot and cold food products thereon and sufficient strength to support such food products to be cut;
(b) a substantially solid first surface of said first member having a first predetermined size for holding such food products to be cut;
(c) a substantially solid second surface of said first member having a second predetermined size; and
(d) a means disposed adjacent at least one edge of said first member for allowing juices from such food products to be cut to drain from said cutting board, said means including at least one elongated aperture formed through said first member adjacent one predetermined end thereof, said at least one elongated aperture being elongated in a horizontal direction when said cutting board is disposed in a horizontal direction during use.

2. The cutting board, according to claim 1, wherein said predetermined material is selected from a group consisting of high density polyethylene, polypropylene and wood.

3. The cutting board, according to claim 2, wherein said wood includes at least one of solid wood, laminated wood and ingrained wood.

4. The cutting board, according to claim 1, wherein said predetermined shape is substantially one of rectangular, oval, square and circular.

5. The cutting board, according to claim 4, wherein said predetermined shape is substantially rectangular

6. The cutting board, according to claim 1, wherein said means for allowing juices from such food products to be cut to drain from said cutting board include a plurality of apertures.

7. The cutting board, according to claim 6, wherein said plurality of apertures are disposed closely adjacent an outer edge of said first member.

8. The cutting board, according to claim 1, wherein said second predetermined size is smaller than said first predetermined size.

9. In combination with a drip pan tray used for cooking a food product therein and having a first predetermined shape and having a base and a pair of sidewalls and endwalls connected to said base, the improvement comprising a cutting board mountable on said drip pan tray, said cutting board including:
(a) a first member having a first predetermined shape and a predetermined thickness, said first member including at least two outer edges having a bottom surface engageable with an upper surface of at least two radially opposed sides of said drip pan tray, said first member having sufficient cut resistant properties and heat resistant properties for cutting at least one of hot and cold food products thereon and sufficient strength to support such food products to be cut;
(b) a first surface of said first member having a first predetermined size for holding such food products to be cut;
(c) a second surface of said first member having a second predetermined size; and
(d) a means for allowing juices from such food products to be cut to drain from said cutting board.

10. The combination, according to claim 9, wherein said predetermined material is selected from a group consisting of high density polyethylene, polypropylene and wood.

11. The combination, according to claim 10, wherein said wood includes at least one of solid wood, laminated wood and ingrained wood.

12. The combination, according to claim 9, wherein said predetermined shape is substantially one of rectangular, oval, square and circular.

13. The combination, according to claim 12, wherein said predetermined shape is substantially rectangular.

14. The combination, according to claim 13, wherein said cutting board fits securely to a top of said sidewalls and said endwalls of said substantially rectangular drip pan tray.

15. The combination, according to claim 9, wherein said second predetermined size being smaller than said first predetermined size.

16. The cutting board, according to claim 9, wherein said means for allowing juices from such food products to be cut to drain from said cutting board include a plurality of apertures.

17. The cutting board, according to claim 16, wherein said plurality of apertures are disposed closely adjacent an outer edge of said first member.

18. The cutting board, according to claim 9, wherein said at least two outer edges of said first member are engageable with two radially opposed sidewalls of said drip pan tray.

19. The cutting board, according to claim 9, wherein said at least two outer edges of said first member are engageable with two radially opposed endwalls of said drip pan tray.
